(19) United States
(12) Patent Application Publication
(10) Pub. No.: US 2025/0355240 A1
(43) Pub. Date: Nov. 20, 2025

(54) Tunable Lens with Pivoting Shape Memory Alloy Actuators

(71) Applicant: Apple Inc., Cupertino, CA (US)

(72) Inventors: Daniel J. Burbridge, Cambridge (GB); Oliver Hart, Cambridge (GB)

(21) Appl. No.: 19/195,488

(22) Filed: Apr. 30, 2025

Related U.S. Application Data
(60) Provisional application No. 63/647,263, filed on May 14, 2024.

(51) Int. Cl. G02B 26/08

(52) U.S. Cl. CPC G02B 26/0875

(57) ABSTRACT

An electronic device may include a lens module with a tunable lens. The tunable lens may include a flexible lens element and a lens shaping structure attached to the flexible lens element. The lens shaping structure may include a plurality of tabs that are each coupled to a respective actuator. The actuator may move the tab up and down along an axis of displacement. The actuator may have a structure that is configured to rotate about a pivot structure. At least one shape memory alloy (SMA) wire may be attached to an upper portion of the structure and at least one SMA wire may be attached to a lower portion of the structure. The SMA wires may be controlled to selectively rotate the structure, thereby controlling the position of a tab along the axis of displacement.

This application claims the benefit of U.S. provisional patent application No. 63/647,263, filed May 14, 2024, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

An actuator may include a pivot structure, a structure with an opening that is aligned with the pivot structure, at least one shape memory alloy wire that is configured to selectively rotate the structure about the pivot structure, and a brake assembly that is configured to selectively fix a position of the structure. The pivot structure may have first and second opposing sides, the at least one shape memory alloy wire may have a first anchor on the first side of the pivot structure and a second anchor on the second side of the pivot structure, and the second anchor may be attached to the structure.

An actuator may include a pivot structure, a structure with an opening that is aligned with the pivot structure, first and second shape memory alloy wires that are configured to selectively pull an upper portion of the structure, third and fourth shape memory alloy wires that are configured to selectively pull a lower portion of the structure, and a brake assembly that is configured to selectively fix a position of the structure.

A tunable lens may include a lens element having a periphery, a conductive lens shaping element attached to the periphery of the lens element, and a plurality of actuators distributed around the periphery. Each actuator in the plurality of actuators may be configured to adjust a position of the conductive lens shaping element and each actuator in the plurality of actuators may include a conductive structure that is attached to the conductive lens shaping element and at least one shape memory alloy wire that is configured to selectively pull the conductive structure. For each actuator, the lens shaping element may form part of a current return path for the at least one shape memory alloy wire.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a top view of an illustrative tunable lens with a lens shaping structure in accordance with some embodiments.

FIG. 7 is a side view of an illustrative SMA-based actuator in accordance with some embodiments.

FIG. 8 is a side view of the illustrative SMA-based actuator of FIG. 7 after a counterclockwise rotation in accordance with some embodiments.

FIG. 9 is a side view of an illustrative brake assembly with guide structures that include spring-loaded ball bearings in accordance with some embodiments.

FIG. 10 is a top view of an illustrative SMA-based actuator with four SMA drive wires in accordance with some embodiments.

FIG. 11A is a side view of an illustrative SMA-based actuator showing a rotating structure and a flexure before a rotation of the rotating structure in accordance with some embodiments.

FIG. 11B is a side view of the illustrative SMA-based actuator of FIG. 11B after a rotation of the rotating structure in accordance with some embodiments.

FIG. 12 is a side view of an illustrative SMA-based actuator that is attached to a conductive lens shaping element that serves as a current return path for SMA wires in the SMA-based actuator in accordance with some embodiments.

FIG. 13 is a side view of an illustrative SMA-based actuator with SMA wires, a brake assembly, and an attached component all formed on the same side of a pivot structure in accordance with some embodiments.

FIG. 14 is a side view of an illustrative SMA-based actuator with SMA wires anchored on first and second opposing sides of a pivot structure in accordance with some embodiments.

FIG. 15 is a side view of an illustrative SMA-based actuator with position sensing components in accordance with some embodiments.

FIG. 16 is a side view of an illustrative SMA-based actuator with a brake structure and SMA wires that bias a structure in the same direction in accordance with some embodiments.

### DETAILED DESCRIPTION

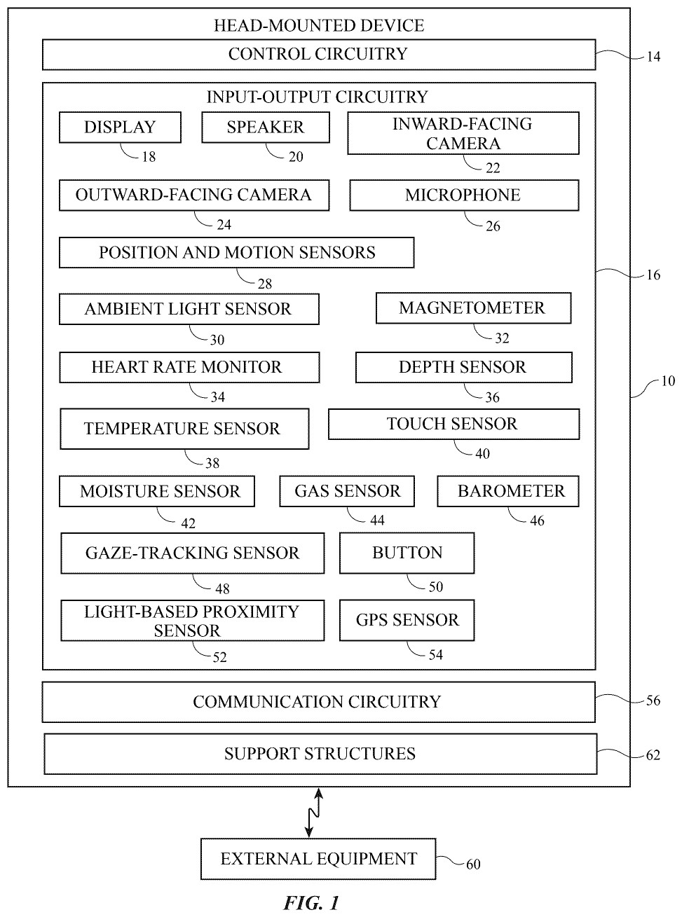

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHZ), a cellular low-midband (LMB) (e.g., 1400 to 1550 MHZ), a cellular midband (MB) (e.g., from 1700 to 2200MHz), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHZ (e.g., 3G bands, 4G LTE bands, 5G New Radio Frequency Range 1 (FR1) bands below 10 GHz, etc.), a near-field communications (NFC) band (e.g., at 13.56 MHZ), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHZ and/or a second UWB communications band at 8.0 GHZ), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHZ and 40 GHz, a Kᵤ communications band between about 12 GHZ and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHZ), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, carbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

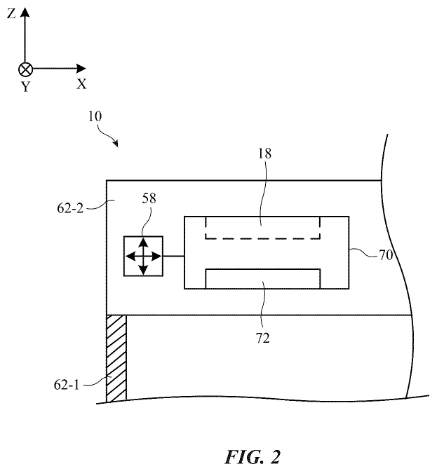

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 14 during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element. The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

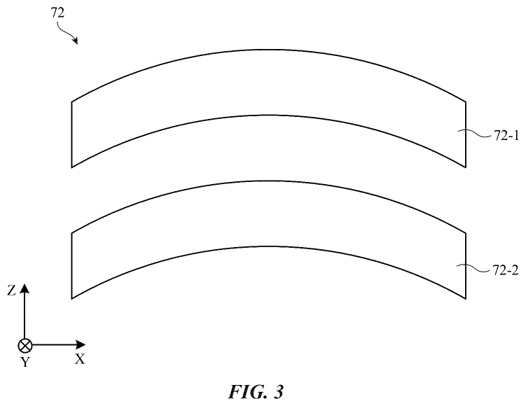

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable. In one example, lens element 72-1 is a non-adjustable lens element whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 26, or another structure in electronic device 10.

In contrast with lens element 72-1, lens element 72-2 may not be a removable lens element. Lens element 72-2 may therefore sometimes be referred to as a permanent lens element, non-removable lens element, etc. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

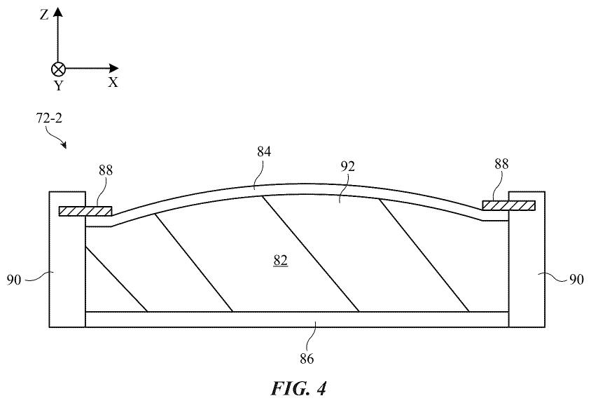

FIG. 4 is a cross-sectional side view of adjustable fluid-filled lens element 72-2. As shown, fluid-filled chamber 82 (sometimes referred to as chamber 82, fluid chamber 82, primary chamber 82, etc.) that includes fluid 92 is interposed between lens elements 84 and 86. Lens elements 84 and 86 may sometimes be referred to as part of chamber 82 or may sometimes be referred to as separate from chamber 82. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, shape memory alloy (SMA), motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. In one example, lens element 84 is an elastomeric lens element whereas lens element 86 is a rigid lens element.

Elastomeric lens elements (e.g., lens element 84 in FIGS. 4 and 5) may be formed from a natural or synthetic polymer that has a low Young's modulus for high flexibility. For example the elastomeric membrane may be formed from a material having a Young's modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements (e.g., lens element 86 in FIGS. 4 and 5) may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, greater than 50 GPa, etc.

In addition to lens elements 84 and 86 and fluid-filled chamber 82, lens module 72-2 also includes a lens shaping element 88. Lens shaping element 88 may be coupled to one or more actuators 90 (e.g., positioned around the circumference of the lens module). The lens shaping element 88 may also be coupled to lens element 84. Actuators 90 may be adjusted to position lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power of lens module 72-2) may be adjusted. An example of actuators 90 and lens shaper 88 being used to change the curvature of lens element 84 in FIG. 5. As shown, lens shaper 88 is moved in direction 94 by actuators 90. This results in lens element 84 having more curvature in FIG. 5 than in FIG. 4.

The example of tunable lens element 72-2 being a fluid-filled lens element is merely illustrative. In general, tunable lens element 72-2 may be any desired type of tunable lens element with adjustable optical power.

The shape (and corresponding optical power) of tunable lens element 72-2 may be adjusted in response to information from any of the components in input-output circuitry 16.

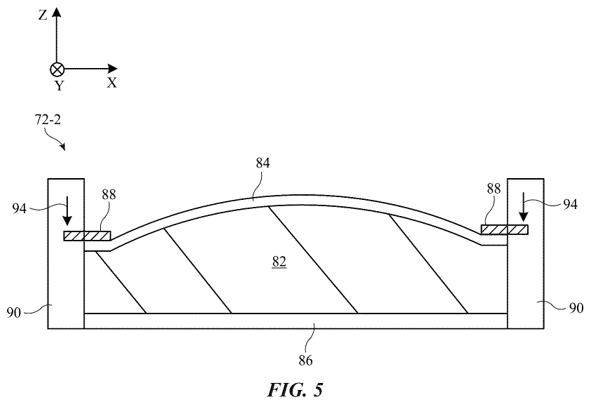

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping element may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping element. Distance 96 and 98 may be less than 100 millimeters, less than 60 millimeters, less than 40 millimeters, less than 30 millimeters, greater than 10 millimeters, greater than 20 millimeters, between 10 and 50 millimeters, etc.

Lens shaping element 88 has a plurality of tabs 88E that extend from the main portion of the lens shaping element. The tabs 88E (sometimes referred to as extensions 88E, actuator points 88E, etc.) may each be coupled to a respective actuator 90. Each actuator may selectively move its respective extension 88E up and down (e.g., in the Z-direction) to control the position of tab 88E in the Z-direction.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) allow for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young's modulus for high flexibility, as discussed above in greater detail) or semi-rigid (e.g., formed from a semi-rigid material that is stiff and solid, but not inflexible, as discussed above in greater detail). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal). The rigidity of lens shaping element 88 may be selected such that the lens shaping element assumes desired target shapes when manipulated by the actuators around its perimeter.

One or more structures such as a lens housing 102 (sometimes referred to as housing 102, lens chassis 102, chassis 102, support structure 102, bezel 102, ring-shaped housing 102, ring-shaped chassis 102, etc.) may also be included in tunable lens element 72-2. Actuators 90 may be positioned within lens housing 102. Lens housing 102 may optionally define a portion of the fluid-filled chamber 82. Lens housing 102 may extend in a ring around the periphery of the tunable lens.

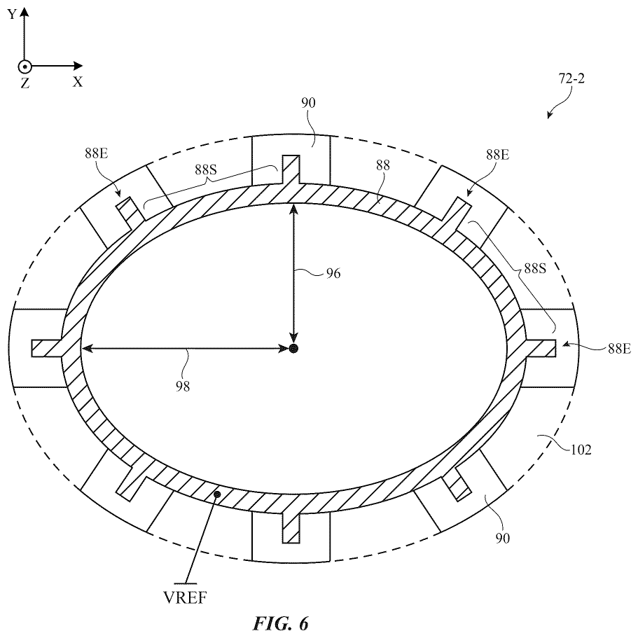

FIG. 7 is a cross-sectional side view of an illustrative actuator 90 from FIG. 6. In the example of FIG. 7, actuator 90 is a shape memory alloy (SMA) actuator. As shown in FIG. 7, the actuator may include a pivot assembly 202 and a brake assembly 204.

Pivot assembly 202 includes a structure 206 (sometimes referred to as rotating structure 206, moveable structure 206, main structure 206, etc.) that is configured to rotate around pivot structure 208. Pivot structure 208 may include a pin or other desired structure. Structure 206 may have an opening that is aligned with and receives pivot structure 208. As shown in FIG. 7, rotating structure 206 may include a first protruding portion 206-P1, a second protruding portion 206-P2, and a third protruding portion 206-P3. The item intended to be moved by actuator 90 may be attached to third protruding portion 206-P3. In this example, the item intended to be moved by actuator 90 is extension 88E but other components may be moved by actuator 90 if desired.

FIG. 7 shows how a portion of lens shaping element 88 such as extension 88E may be attached to third protruding portion 206-P3. Rotation of structure 206 around pivot structure 208 therefore causes displacement of extension 88E along the Z-direction. Pivot structure 208 may be a rigid structure such as a pin that is aligned with an opening in structure 206. This example is merely illustrative. Pivot structure 208 may instead be a flexure formed from plastic, stainless steel, or another desired material. The flexure may bend while structure 206 rotates. Pivot structure 208 does not necessarily define a fixed pivot location when the pivot structure is formed by a flexure. When pivot structure 208 is a flexure, the flexure may be arranged in tension to allow for compliance without risk of buckling. The flexure may form a simple cantilever, which advantageously has a low manufacturing cost and complexity. The flexure may optionally be designed to tune the stiffness in different rotational and translational directions (e.g., depending on the requirements for actuator 90 and the load the actuator is driving).

A first SMA wire 214 may be connected between anchor structures 210 and 212. Anchor structures 210 and 212 (sometimes referred to as connector structures 210 and 212, mechanical connection structures 210 and 212, electrical connection structures 210 and 212, mechanical and electrical connection structures 210 and 212, etc.) may be both mechanically and electrically connected to SMA wire 214. Mechanically, anchor structure 212 may be attached to a fixed structure in tunable lens 72-2 such as lens housing 102 or a housing for the actuator whereas anchor structure 210 may be attached to portion 206-P1 of structure 206. Anchor structures 210 and 212 may also provide electrical connections to SMA wire 214. Control circuitry 14 may control voltages applied to anchor structures 210 and 212 to control a current through SMA wire 214. The current through SMA wire 214 may be adjusted to selectively contract SMA wire 214. When a current is applied to SMA wire 124 to cause the SMA wire to contract, the contraction may apply a force to anchor structure 210 (and therefore portion 206-P1 of structure 206) in the negative X-direction.

The aforementioned example of the anchor structures being attached to other components (e.g., lens housing 102, portion 206-P1, etc.) is merely illustrative. The anchor structures may be discrete structures that are attached to other device components. Alternatively, the anchor structures may be portions of the other device components. For example, a portion of lens housing 102 and/or structure 206 may serve as mechanical anchor structures for SMA wire 214 (without an intervening discrete anchor structure). This is true for all of the anchor structures described herein.

A second SMA wire 220 may be connected between anchor structures 216 and 218. Anchor structures 216 and 218 (sometimes referred to as connector structures 216 and 218, mechanical connection structures 216 and 218, electrical connection structures 216 and 218, mechanical and electrical connection structures 216 and 218, etc.) may be both mechanically and electrically connected to SMA wire 220. Mechanically, anchor structure 218 may be attached to a fixed structure in tunable lens 72-2 such as lens housing 102 or a housing for the actuator whereas anchor structure 216 may be attached to portion 206-P2 of structure 206. Anchor structures 216 and 218 may also provide electrical connections to SMA wire 220. Control circuitry 14 may control voltages applied to anchor structures 216 and 218 to control a current through SMA wire 220. The current through SMA wire 220 may be adjusted to selectively contract SMA wire 220. When a current is applied to SMA wire 220 to cause the SMA wire to contract, the contraction may apply a force to anchor structure 216 (and therefore portion 206-P2 of structure 206) in the negative X-direction.

Control circuitry 14 may therefore control the contraction of SMA wires 214 and 220, which selectively rotates structure 206 around pivot structure 208, which selectively moves extension 88E along the Z-direction.

Actuator 90 may include brake assembly 204 in addition to pivot assembly 202. Brake assembly 204 may be configured to selectively apply a bias force to rotating structure 206 to hold the rotating structure 206 in a fixed position. The brake may fix the position of rotating structure 206 when actuator 90 is not receiving power. Including the brake may therefore reduce the power consumption required to operate actuator 90.

As shown in FIG. 7, brake assembly 204 may include a brake structure 222. One or more bias structures such as springs may be coupled between brake structure 222 and anchor 224. In FIG. 7, springs 228 and 230 are coupled between brake structure 222 and anchor 224. Anchor structure 224 may be attached to a fixed structure in tunable lens 72-2 such as lens housing 102 or a housing for the actuator. Springs 228 and 230 may bias brake structure 222 in the positive X-direction towards structure 206. In the absence of a force from SMA wire 232, brake structure 222 presses into structure 206 to fix the position of structure 206. As shown in FIG. 7, brake structure 222 may have a concave surface 222-C that mates with a corresponding convex surface 206-C of structure 206.

A third SMA wire 232 may be connected between anchor structures 226 and 234. Anchor structures 226 and 234 (sometimes referred to as connector structures 226 and 234, mechanical connection structures 226 and 234, electrical connection structures 226 and 234, mechanical and electrical connection structures 226 and 234, etc.) may be both mechanically and electrically connected to SMA wire 232. Mechanically, anchor structure 226 may be attached to a fixed structure in tunable lens 72-2 such as lens housing 102 or a housing for the actuator whereas anchor structure 234 may be attached to brake structure 222. Anchor structures 226 and 234 may also provide electrical connections to SMA wire 232. Control circuitry 14 may control voltages applied to anchor structures 226 and 234 to control a current through SMA wire 232. The current through SMA wire 232 may be adjusted to selectively contract SMA wire 232. When a current is applied to SMA wire 232 to cause the SMA wire to contract, the contraction may apply a force to anchor structure 234 (and therefore brake structure 222) in the negative X-direction.

When SMA wire 232 pulls brake structure 222 with sufficient force to overcome the bias force provided by bias structures 228/230, brake structure 222 moves in the negative X-direction. This may be referred to as releasing the brake. While the brake is released, structure 206 may rotate freely around pivot structure 208. It is noted that the brake does not need to be fully disengaged to enable movement of structure 206. The frictional force between the brake structure 222 and structure 206 just needs to be less than the drive force to allow movement of structure 206. SMA wires 214/220 may be used to rotate structure 206 while the brake is released. Once structure 206 is in a desired position, the brake may be engaged by relaxing SMA wire 232 such that brake structure 222 is again biased into structure 206. The position of structure 206 is thereafter fixed while the brake is engaged.

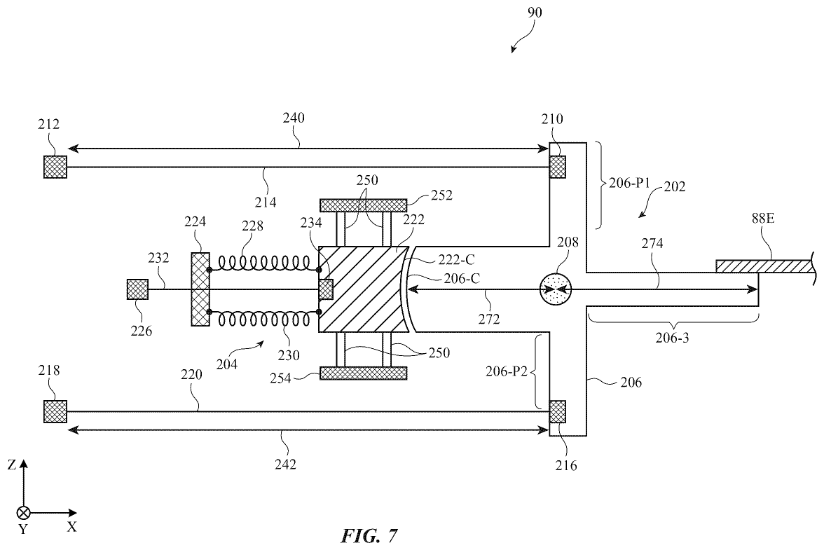

FIGS. 7 and 8 show an example of structure 206 being rotated to move extension 88E in the positive Z-direction. In FIG. 7, SMA wire 214 has a first length 240 and SMA wire 220 has a second length 242. In FIG. 8, SMA wire 214 has been contracted and the length of SMA wire 214 has been reduced to a third length 244 that is less than first length 240 from FIG. 7. Meanwhile SMA wire 220 has been relaxed and the length of SMA wire 220 in FIG. 8 has been increased to a fourth length 246 that is greater than second length 242 from FIG. 7. As shown in FIG. 8, this change in the forces applied by SMA wires 214 and 220 causes structure 206 (including protruding portion 206-P3 and therefore extension 88E) to rotate in counterclockwise direction 248. Rotating structure 206 counterclockwise in this manner moves extension 88E in the positive Z-direction. In the opposite arrangement (e.g., when length 244 increases and length 246 decreases), structure 206 may rotate clockwise which moves extension 88E in the negative Z-direction.

As shown in FIG. 7, structure 206 may have a length 272 between the center of pivot structure 208 and convex surface 206-C and a length 274 between the center of pivot structure 208 and the end of protruding portion 206-3. The friction force at the interface of surfaces 222-C and 206-C may be proportional to the ratio of the gearing between extension 88E and frictional translation. To lower the normal force required on the friction surface, the ratio of the length 272 to length 274 may be increased. Lowering the normal force using a relatively high ratio of length 272 to length 274 may allow for a smaller and more compact bias structure(s) 228/230, lower stresses within the system, and a lower required force for SMA wire 232 that releases the braking structure. The ratio of length 272 to length 274 may be at least 0.25, at least 0.3, at least 0.4, at least 0.5, at least 0.75, at least 1, at least 1.5, at least 2, at least 3, etc.

To improve the performance of actuator 90, it may be desirable to include one or more components that limit undesired shifting of brake structure 222 along the Z-direction. If brake structure 222 shifts along the Z-direction, there may be backlash that prevents extension 88E from being moved in a desired manner.

To mitigate motion of brake structure 222 in the Z-direction, brake structure 222 may be attached to one or more guide structures 250. First and second guide structures 250 may be attached between anchor structure 252 and brake structure 222 on the positive Z-side of brake structure 222. Third and fourth guide structures 250 may be attached between anchor structure 254 and brake structure 222 on the negative Z-side of brake structure 222.

Anchor structures 252 and 254 may be attached to a fixed structure in tunable lens 72-2 such as lens housing 102 or a housing for the actuator. Each one of guide structures 250 may have a high stiffness in the Z-direction and the Y-direction but a low stiffness in the X-direction. The guide structures may therefore limit undesired motion of brake structure 222 along the Z-axis while allowing the desired motion of brake structure 222 along the X-axis. Guide structures 250 in FIG. 7 may be referred to as flexures. The flexures may be formed from any desired material (e.g., plastic, a metal such as aluminum, etc.). The flexures may have a first dimension in the Z-direction, a second dimension in the Y-direction, and a third dimension in the X-direction. The third dimension may be smaller than the first and/or second dimensions. The first dimension may be at least 2× greater than the third dimension, at least 4× greater than the third dimension, at least 8× greater than the third dimension, at least 16× greater than the third dimension, etc. The second dimension may be at least 2× greater than the third dimension, at least 4× greater than the third dimension, at least 8× greater than the third dimension, at least 16× greater than the third dimension, etc.

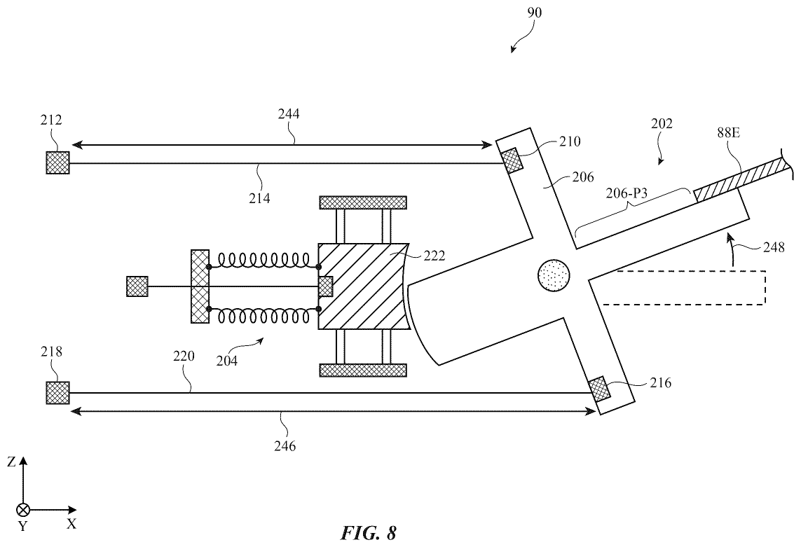

The example of forming guide structures using flexures as in FIG. 7 is merely illustrative. In another possible arrangement, shown in FIG. 9, the guide structures may be formed by spring-loaded ball bearings 260 (sometimes referred to as guide structures 260). On the positive Z-side of brake structure 222, the spring-loaded ball bearings 260 may include one or more springs 262 attached between ball bearings 264 and anchor 252. The springs 262 may bias ball bearings 264 into brake structure 222 in the negative Z-direction. On the negative Z-side of brake structure 222, ball bearings 266 may be interposed between anchor 254 and brake structure 222. The spring-loaded ball bearings of FIG. 9 may limit undesired motion of brake structure 222 along the Z-axis while allowing the desired motion of brake structure 222 along the X-axis.

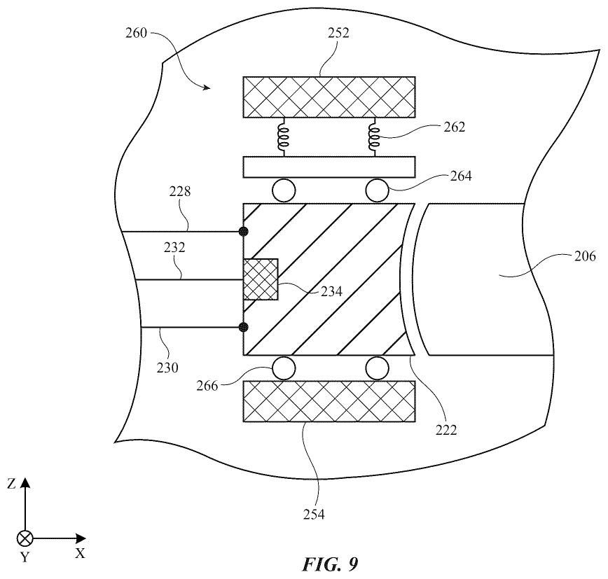

FIG. 7 shows an example where actuator 90 includes an upper SMA wire 214 and a lower SMA wire 220. These SMA wires are used to manipulate the position of structure 206 and may sometimes be referred to as SMA drive wires. In some arrangements, these two SMA wires may be the only two drive wires in actuator 90. Alternatively, there may be an upper SMA wire and a lower SMA wire on each lateral side of actuator 90. FIG. 10 is a top view of an illustrative actuator 90 with four SMA drive wires.

In the example of FIG. 10, there is a first SMA wire 214-1 attached between an upper portion of structure 206 (at anchor 210-1) and anchor 212-1. Similarly, a second SMA wire 214-2 may be attached between an upper portion of structure 206 (at anchor 210-2) and anchor 212-2. Each one of SMA wires 214-1 and 214-2 may have the same arrangement and properties as shown and discussed in connection with SMA wire 214 of FIGS. 7 and 8. SMA wires 214-1 and 214-2 may work in parallel to selectively pull the upper portion of structure 206 (e.g., protruding portion 206-Pl as shown in FIG. 7).

Each upper SMA wire 214 may overlap a corresponding lower SMA wire 220. In other words, there are four drive wires in FIG. 10 with two upper wires attached to first and second opposing sides (e.g., left and right sides) of structure 206 and two lower wires attached to first and second opposing sides (e.g., left and right sides) of structure 206. By pulling on both the left and right sides of structure 206, the applied load to either the top or bottom of structure 206 is balanced and structure 206 is less likely to buckle out of plane.

In FIG. 10, because there are two wires for each single wire in FIG. 7, the wires may have a smaller diameter than in FIG. 7. The thinner diameter wires of FIG. 10 may have the benefit of shorter transition times and may be more efficient in power consumption. Additionally, a first wire may serve as a return path for a second wire. Each SMA wire has an associated current that runs through the SMA wire. To create the current through the SMA wire, a voltage difference is created at the first and second anchors associated with each wire. Control circuitry 14 may control the voltage at the first and second anchors to control the magnitude of the current running through the SMA wire. In FIG. 10, because SMA wires 214-1 and 214-2 are controlled in unison, SMA wire 214-2 may serve as a current return path for SMA wire 214-1. In this example, control circuitry 14 may control the voltage applied to anchor 212-1 and 212-2. Anchors 210-1 and 210-2 may be electrically connected. Control circuitry 14 may control the voltages at anchors 212-1 and 212-2 to create a current that runs along path 270 along SMA wire 214-1, through anchors 210-1 and 210-2, and back along SMA wire 214-2 to anchor 212-2. This technique may be used for any pair of SMA wires that is controlled in unison (e.g., a first lower SMA wire below upper SMA wire 214-2 may serve as a current return path for a second lower SMA wire below upper SMA wire 214-1).

As shown in FIG. 10, the brake SMA wire 232 from FIG. 7 may also be split into first and second SMA wires to better balance the load. In the example of FIG. 10, there is a first SMA wire 232-1 attached between brake structure 222 (at anchor 234-1) and anchor 226-1. Similarly, a second SMA wire 232-2 may be attached between brake structure 222 (at anchor 234-2) and anchor 226-2. Each one of SMA wires 232-1 and 232-2 may have the same arrangement and properties as shown and discussed in connection with SMA wire 232 of FIGS. 7 and 8. SMA wires 232-1 and 232-2 may work in parallel to selectively pull brake structure 222. SMA wire 232-2 may serve as the current return path for SMA wire 232-1.

In the example of FIGS. 7 and 8, extension 88E is attached directly to protruding portion 206-P3 of structure 206. Consequently, rotation of structure 206 may cause some movement of extension 88E along the X-direction in addition to along the Z-direction. In some cases, the movement of extension 88E along the X-direction may be acceptable. However, it may sometimes be desirable for extension 88E to move along the Z-direction only (with little to no displacement along the X-direction).

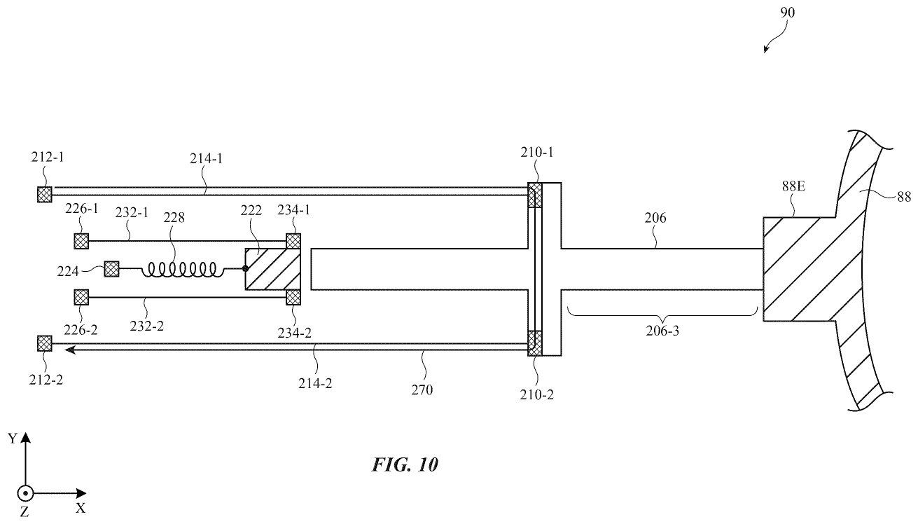

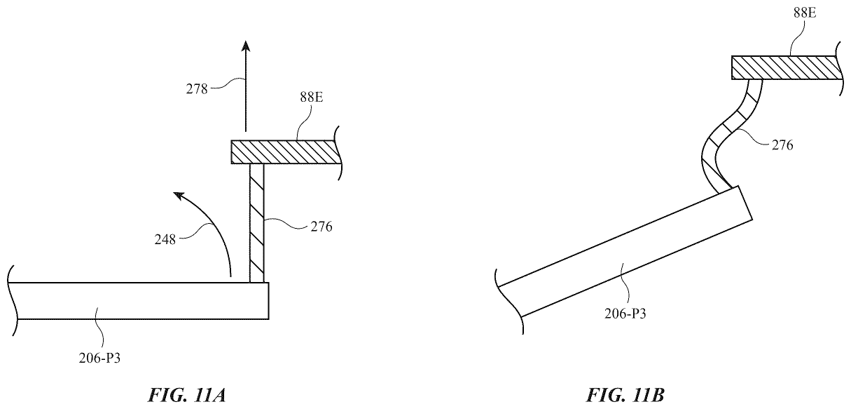

FIGS. 11A and 11B show an illustrative example where rotation of structure 206 causes extension 88E to move along the Z-direction only (with little to no displacement along the X-direction). As shown in FIG. 11A, extension 88E may be attached to portion 206-P3 of structure 206 by flexure 276. Flexure 276 may have a high stiffness in the Z-direction and the Y-direction but a low stiffness in the X-direction. Flexure 276 therefore allows displacement between structure 206 and extension 88E in the X-direction but not along the Y-direction of Z-direction. Consequently, rotation of structure 206 (e.g., in counterclockwise direction 248 in FIG. 11A) may cause extension 88E to move only in the positive Z-direction as indicated by arrow 278 in FIG. 11A (with no displacement in the X-direction). FIG. 11A shows extension 88E, flexure 276, and structure 206 before the rotation of structure 206 in counterclockwise direction 248. FIG. 11B shows extension 88E, flexure 276, and structure 206 after the rotation of structure 206 in counterclockwise direction 248.

Flexure 276 may be formed from any desired material (e.g., plastic, a metal such as aluminum, etc.). Flexure 276 may have a first dimension in the Z-direction, a second dimension in the Y-direction, and a third dimension in the X-direction. The third dimension may be smaller than the first and/or second dimensions. The first dimension may be at least 2× greater than the third dimension, at least 4× greater than the third dimension, at least 8× greater than the third dimension, at least 16× greater than the third dimension, etc. The second dimension may be at least 2× greater than the third dimension, at least 4× greater than the third dimension, at least 8× greater than the third dimension, at least 16× greater than the third dimension, etc.

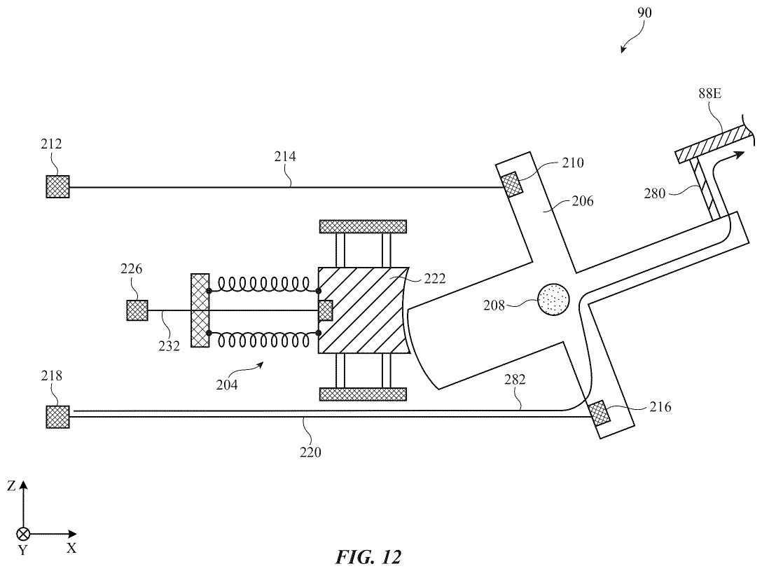

As previously mentioned, control circuitry 14 may control voltages applied to anchor structures to control a current through SMA wires. In one possible arrangement, shown in FIG. 12, structure 206 and lens shaping structure 88 may be formed from conductive material (e.g., copper, aluminum, etc.). Metal extension 88E may be attached to structure 206 by a conductive structure 280. Conductive structure 280 may be welded to extension 88E and structure 206, attached to extension 88E and structure 206 using conductive adhesive, etc.

Because structures 206, 280, and 88 are all conductive, the SMA wire anchors are electrically connected to lens shaper 88 through structures 206 and 280. FIG. 12 shows an example of current 282 flowing from anchor 218, through wire 220, anchor 216, structure 206, and structure 280 to lens element 88. Control circuitry 14 may bias lens element 88 to a reference voltage such that lens element 88 serves as part of the return path for SMA wire 220. All of the SMA wires for all of the actuators may share this common return path if desired. Returning to FIG. 6, control circuitry 14 may apply a reference voltage V_{REF} to lens shaping element 88. Lens shaping element 88 may serve as a common return path for each SMA wire in each actuator 90.

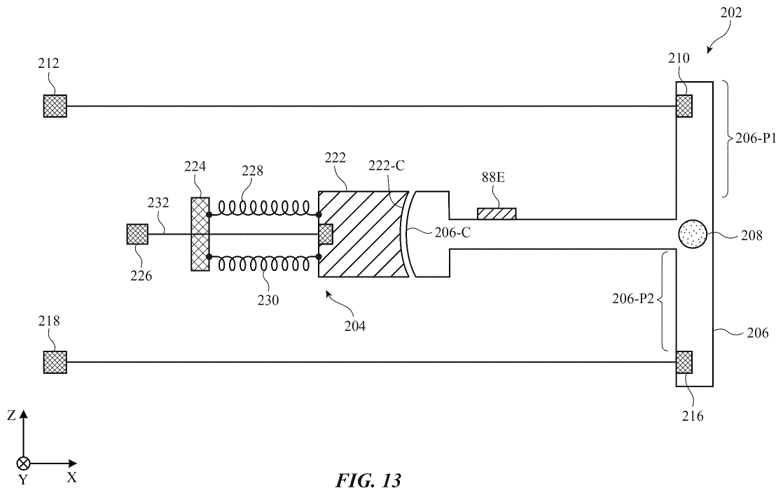

In the example of FIGS. 7 and 8, pivot structure 208 is interposed between extension 88E and SMA wires 214 and 220. In other words, the SMA drive wires and the component (88E) moved by structure 206 are on opposing sides of pivot structure 208. This example is merely illustrative. In an alternative arrangement, shown in FIG. 13, the SMA drive wires and the component (88E) moved by structure 206 are on the same side of pivot structure 208.

Braking assembly 204 in FIG. 13 may be the same as in FIG. 7. The majority of pivot assembly 202 in FIG. 13 may be the same as in FIG. 7. However, in FIG. 13 the third protruding portion 206-P3 on the positive X-side of pivot structure 208 is omitted. The extension 88E is instead positioned on the negative X-side of pivot structure 208 (similar to the SMA drive wires). In this example, rotating structure 206 counterclockwise moves extension 88E in the negative Z-direction (instead of the positive Z-direction as in FIGS. 7 and 8) and rotating structure 206 clockwise moves extension 88E in the positive Z-direction (instead of the negative Z-direction as in FIGS. 7 and 8). The arrangement of FIG. 13 may reduce the overall footprint of actuator 90 in the X-direction. Alternatively, the SMA drive wires may be longer while maintaining the same overall footprint of actuator 90 (compared to FIG. 7). Longer SMA drive wires advantageously results in a greater wire stroke, less gearing, and less required wire force. Additionally, the longer wires enable smaller diameter wire and therefore faster transitions.

In the examples of FIGS. 7 and 13, braking assembly 204 is formed on the same side of pivot structure 208 as the SMA drive wires. This example is merely illustrative and the braking assembly may instead be formed on the opposite side of pivot structure as the SMA drive wires.

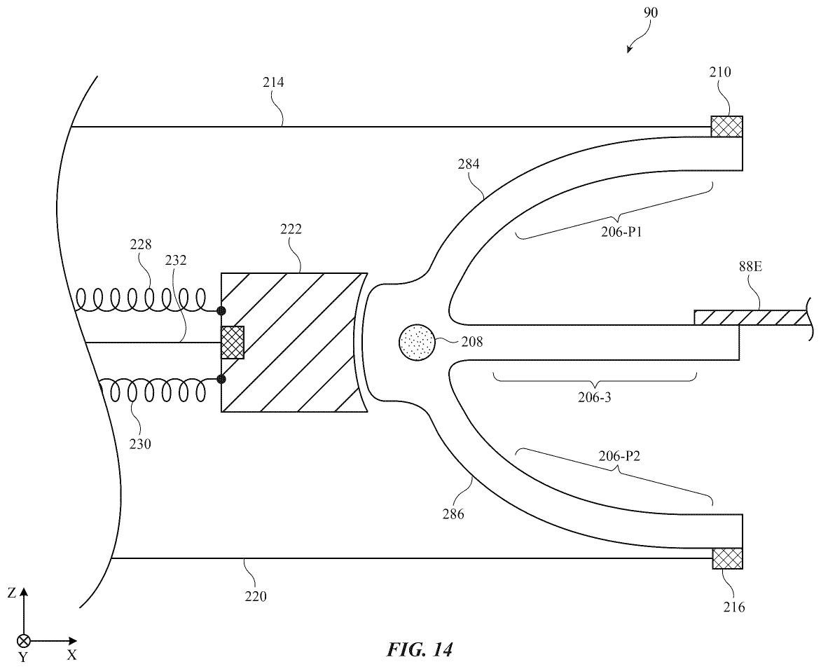

In FIG. 7, protruding portions 206-P1 and 206-P2 extend along the Z-direction from pivot structure 208. Accordingly, there is little to no displacement along the X-direction between anchor points 210/216 and pivot structure 208. This example is merely illustrative. In another possible arrangement, shown in FIG. 14, anchors 210 and 216 are shifted in the positive X-direction relative to pivot structure 208.

Shifting the anchor points as in FIG. 14 may allow for SMA wires 214 and 220 to be longer than in FIG. 7, which advantageously results in a greater wire stroke, less gearing, and less required wire force. Additionally, the longer wires may enable a smaller diameter wire and therefore faster transitions.

In addition to the benefit of longer SMA wires, the arrangement of FIG. 14 may result in the mechanical advantage changing non-linearly over stroke in a beneficial way. In general, it is most efficient to operate a SMA wire at a constant stress level. In FIG. 14, contracting one SMA drive wire increases the lever arm for the contracting wire and decreases the lever arm for the other wire. This results in increased stroke from the actuator compared to the arrangement of FIG. 7 where there is a minimal change in lever arms when one of the SMA drive wires contracts.

The load force from extension 88E (e.g., the object being moved by the actuator) acts like a spring in that the force required at the center of the stroke is small, but large at the edge of stroke. In the absence of gearing changing with stroke, the use of SMA in the central region where required force is low may be inefficient. By changing gearing over stroke we can make more efficient use of the SMA in the central region here by increasing the load and actuation distance per unit contraction while minimizing load and distance per unit contraction towards the edge of stroke. The overall strain of the SMA may be increased, but only if the maximum force on it is reduced. Ultimately, with the arrangement of FIG. 14 the gearing is designed so that the mechanical work done by the SMA wire for a given strain and maximum achieved force is maximized.

The combination of stress and strain and SMA wires 214/220 may be kept below a limit. Gearing a system may desirably reduce wire strain but undesirably increase wire stress. In the arrangement of FIG. 14 with variable gearing, as the gearing is reduced on the contracting wire (which is increasing in stress), the force that this wire needs to provide is reduced and so the stress increases at a slower rate compared to a constantly geared system. In the arrangement of FIG. 14, there may be an increased stroke for a set strain and maximum wire force (compared to FIG. 7), a reduced maximum wire force for a set stroke and strain (compared to FIG. 7), or an increased maximum strain and stroke for a reduced maximum and set design lifetime within limits of the SMA material (compared to FIG. 7).

As shown in FIG. 14, protruding portion 206-3 extends in the positive X-direction with no displacement along the Z-direction. Protruding portion 206-1 extends in the positive X-direction and the positive Z-direction. Protruding portion 206-2 extends in the positive X-direction and the negative Z-direction. Protruding portion 206-1 has a curved surface 284. When SMA wire 214 contracts and/or SMA wire 220 lengthens, SMA wire 214 may abut some or all of curved surface 284. If care is not taken, a changing wire angle through stroke can cause a tight bending radius at anchor 210 and fatigue failures in SMA wire 214. The curvature of surface 284 may be selected to control the angle of SMA wire 214 as a function of lever rotation angle. The curvature of surface 284 may ensure that SMA wire 214 is never too tightly curved (which prevents the aforementioned fatigue failures). As an example, the curvature of surface 284 may prevent SMA wire 214 from having a bend radius less than 20 times the diameter of SMA wire 214 during the stroke.

As with portion 206-1, protruding portion 206-2 has a curved surface 286. When SMA wire 220 contracts and/or SMA wire 214 lengthens, SMA wire 220 may abut some or all of curved surface 286. If care is not taken, a changing wire angle through stroke can cause a tight bending radius at anchor 216 and fatigue failures in SMA wire 220. The curvature of surface 286 may be selected to control the angle of SMA wire 220 as a function of lever rotation angle. The curvature of surface 286 may ensure that SMA wire 220 is never too tightly curved (which prevents the aforementioned fatigue failures). As an example, the curvature of surface 286 may prevent SMA wire 220 from having a bend radius less than 20 times the diameter of SMA wire 220 during the stroke.

Curved surface 284 may have a groove to retain SMA wire 214 when SMA wire 214 abuts the curved surface. The groove may extend in the X-direction along surface 284 with a sufficient width to hold SMA wire 214. Curved surface 286 may have a groove to retain SMA wire 220 when SMA wire 214 abuts the curved surface. The groove may extend in the X-direction along surface 286 with a sufficient width to hold SMA wire 220.

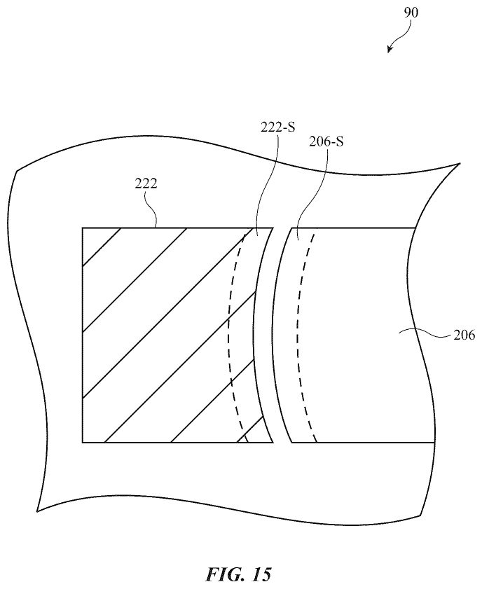

In any of the aforementioned arrangements, braking structure 222 and/or rotating structure 206 may optionally include one or more sensor components. The sensor components may be able to determine a position of rotating structure 206 relative to braking structure 222 (e.g., to determine whether or not the brake is engaged, to determine a relative rotation of rotating structure 206 relative to braking structure 222, etc.). As shown in FIG. 15, braking structure may include sensor components 222-S (sometimes referred to as position sensing components 222-S) and rotating structure 206 may include sensor components 206-S (sometimes referred to as position sensing components 206-S).

There are numerous types of sensing schemes that may be used by sensor components 206-S and 222-S. The sensor components may define a force sensitive resistor, a spring-loaded potentiometer, a capacitive sensor, and/or another desired type of sensor. In the example of a spring-loaded potentiometer, components 222-S may include a resistor and components 206-S may include a spring-loaded plunger that acts on the resistor (with the length of the resistor changing due to the position of the spring-loaded plunger).

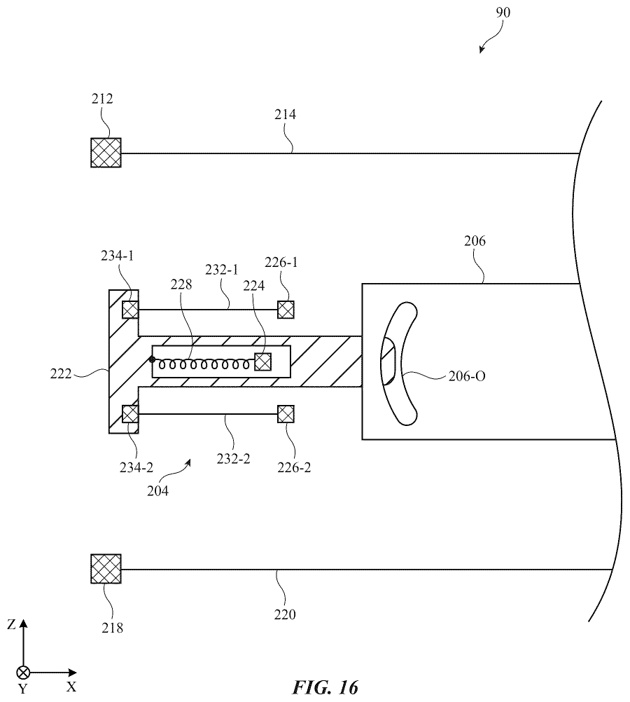

In FIG. 7, brake structure 222 is biased into structure 206 in the positive X-direction by spring 228. SMA drive wires 214 and 220, in contrast, selectively bias structure 206 in the negative X-direction. It may be desirable for the force from SMA drive wires 214 and 220 and brake structure 222 to be applied to structure 206 in the same direction. FIG. 16 is a side view of an actuator of this type.

As shown in FIG. 16, structure 206 may have an opening 206-O (sometimes referred to as a slot) that receives a portion of brake structure 222. Brake structure 222 is biased in the negative X-direction by spring 228. Accordingly, brake structure 222 applies a force in the negative X-direction to structure 206 when the brake is engaged. Brake structure 222 therefore applies force to structure 206 in the same direction as SMA drive wires 214 and 220. SMA wires 232-1 and 232-2 may selectively pull the brake structure in the positive X-direction to release the brake. With this arrangement, structure 206 advantageously only needs to resist loading in one direction.

In another possible arrangement, opening 206-O may be omitted and brake structure 222 may be biased in the negative X-direction against an outer surface of structure 206.

The examples of FIGS. 7-16 where structure 206 is used to move extension 88E along the Z-direction is merely illustrative. In general, the actuators of FIGS. 7-16 may be used in any desired application and may move any desired component along the Z-direction.

The foregoing is merely illustrative and various modifications can be made to the described embodiments. The foregoing embodiments may be implemented individually or in any combination.

What is claimed is:

1. An actuator comprising:
a pivot structure;
a structure with an opening that is aligned with the pivot structure;
at least one shape memory alloy wire that is configured to selectively rotate the structure about the pivot structure; and
a brake assembly that is configured to selectively fix a position of the structure, wherein the pivot structure has first and second opposing sides, the at least one shape memory alloy wire has a first anchor on the first side of the pivot structure and a second anchor on the second side of the pivot structure, and the second anchor is attached to the structure, wherein the structure is configured to move a component in a first direction, wherein the structure has first and second protruding portions on the second side of the pivot structure, wherein the first protruding portion extends in the first direction and a second direction that is orthogonal to the first direction, and wherein the second protruding portion extends in the first direction and a third direction that is opposite the second direction.

2. The actuator defined in claim 1, wherein the at least one shape memory alloy wire comprises a first shape memory alloy wire attached to the first protruding portion and a second shape memory alloy wire attached to the second protruding portion, wherein the first protruding portion has a first curved surface, and wherein the second protruding portion has a second curved surface.

3. The actuator defined in claim 2, wherein the first curved surface has a first groove that is configured to retain the first shape memory alloy wire and wherein the second curved surface has a second groove that is configured to retain the second shape memory alloy wire.

4. The actuator defined in claim 2, wherein the structure comprises a third protruding portion on the second side of the pivot structure, wherein the third protruding portion is interposed between the first and second protruding portions, and wherein the third protruding portion is attached to the component.

5. The actuator defined in claim 4, wherein the brake assembly comprises a brake structure that is selectively biased into a surface of the structure, wherein the structure has a first length between the surface and the pivot structure, wherein the structure has a second length between the pivot structure and an end of the third protruding portion, and wherein a ratio of the first length to the second length is greater than 0.5.

6. The actuator defined in claim 5, wherein the ratio is greater than 1.

7. The actuator defined in claim 1, wherein the brake assembly comprises:
a brake structure;
at least one spring that is configured to bias the brake structure in a first direction towards the structure; and
an additional shape memory alloy wire that is attached to the brake structure.

8. The actuator defined in claim 7, wherein the additional shape memory alloy wire is configured to pull the brake structure away from the structure in a second direction that is opposite the first direction.

9. The actuator defined in claim 7, wherein the brake structure has a surface that is configured to mate with an additional surface on the structure.

10. The actuator defined in claim 9, wherein the surface is a concave surface and wherein the additional surface is a convex surface.

11. The actuator defined in claim 7, wherein the brake assembly further comprises:
a guide structure that is configured to constrain displacement of the brake structure in a second direction that is orthogonal to the first direction while allowing displacement of the brake structure in the first direction.

12. The actuator defined in claim 11, wherein the guide structure comprises a structure with greater thickness in the second direction than the first direction.

13. The actuator defined in claim 11, wherein the guide structure comprises spring-loaded ball bearings.

14. An actuator comprising:
a pivot structure;
a structure with an opening that is aligned with the pivot structure;
first and second shape memory alloy wires that are configured to selectively pull an upper portion of the structure;
third and fourth shape memory alloy wires that are configured to selectively pull a lower portion of the structure; and
a brake assembly that is configured to selectively fix a position of the structure.

15. The actuator defined in claim 14, wherein the first shape memory alloy wire is attached to a left side of the upper portion of the structure, wherein the second shape memory alloy wire is attached to a right side of the upper portion of the structure, wherein the third shape memory alloy wire is attached to the left side of the upper portion of the structure, and wherein the fourth shape memory alloy wire is attached to the right side of the upper portion of the structure.

16. The actuator defined in claim 14, wherein at least one of the brake assembly and the structure comprises one or more sensor components configured to sense a position of the structure relative to the brake assembly.

17. The actuator defined in claim 14, wherein the second shape memory alloy wire forms at least part of a current return path for the first shape memory alloy wire.

18. The actuator defined in claim 14, wherein the structure is configured to move a component in a first direction, wherein the component is attached to a portion of the structure, and wherein the portion of the structure is formed on an opposing side of the pivot structure as the first, second, third, and fourth shape memory alloy wires.

19. The actuator defined in claim 14, wherein the structure is configured to move a component in a first direction, wherein the component is attached to a portion of the structure, and wherein the portion of the structure and the first, second, third, and fourth shape memory alloy wires are all formed on a same side of the pivot structure.

20. A tunable lens comprising:
a lens element having a periphery;
a conductive lens shaping element attached to the periphery of the lens element; and
a plurality of actuators distributed around the periphery, wherein each actuator in the plurality of actuators is configured to adjust a position of the conductive lens shaping element and wherein each actuator in the plurality of actuators comprises:
a conductive structure that is attached to the conductive lens shaping element; and
at least one shape memory alloy wire that is configured to selectively pull the conductive structure, wherein, for each actuator, the lens shaping element forms part of a current return path for the at least one shape memory alloy wire.
